(19) United States
(12) Patent Application Publication
(10) Pub. No.: US 2019/0316996 A1
(43) Pub. Date: Oct. 17, 2019

(54) MOLECULARLY IMPRINTED POLYMER SENSOR

(71) Applicant: NATIONAL UNIVERSITY OF SINGAPORE, Singapore (SG)

(72) Inventors: Fong Yau Sam LI, Singapore (SG); Xuanhao LIN, Singapore (SG)

(73) Assignee: National University of Singapore, Singapore (SG)

(21) Appl. No.: 16/315,528

(22) PCT Filed: Jul. 5, 2017
(86) PCT No.: PCT/SG2017/050342

§ 371 Date: Jan. 4, 2019

(30) Foreign Application Priority Data
Jul. 5, 2016 (SG) 10201605527R

(51) Int. Cl. G01N 1/36; B05D 1/00; B05D 3/10; B01J 20/26; B01J 20/30

(52) U.S. Cl. CPC G01N 1/36; B05D 1/005; B05D 3/107; B01J 20/268; G01N 2001/366; B05D 2506/10; B05D 2518/00; B05D 2203/30; B05D 2350/65; B01J 20/3057

(57) ABSTRACT

There is provided a molecularly imprinted polymer (MIP) sensor for sensing a hydrophobic target molecule, comprising a MIP film comprising a hydrophobic polymer host, such as polyvinylidene difluoride (PVDF) or polystyrene (PS), with one or more binding sites for one or more target molecules, such as parathion methyl (PTM); and a sensing substrate, such as mass sensitive quartz crystal microbalance (QCM). The MIP film is coated on a surface of a sensing substrate. There is also provided a method of making the MIP sensor and a method for detecting/quantifying a target molecule using the MIP sensor.

### TECHNICAL FIELD

The present invention relates to a molecularly imprinted polymer sensor, a method of making the same, and a method for detecting and/or quantifying a target molecule using the molecularly imprinted polymer sensor.

### BACKGROUND

There are many molecularly imprinted polymer sensors in the art. Most of the sensors utilize functionalized polymer films such as polyacrylics (such as polyamide and poly(methyl acrylate)), polydopamine (PDA) and polythiophene, inorganic silica or titania films, biological antibody-antigen-antibody methods, and fluorescent methods to detect and quantify pollutants in water. These methods mainly involve hydrophilic materials and hydrogen bonding. While these sensors have the advantage of detecting hydrophilic analytes, they have difficulties to detect hydrophobic analytes in water.

There is therefore a need for an improved sensor which allows detection of hydrophobic analytes.

### SUMMARY OF THE INVENTION

The present invention seeks to address these problems, and/or to provide an improved sensor which allows for the detection and quantification of hydrophobic analytes. In particular, the invention relates to a molecularly imprinted polymer sensor, a method of making the same, and a method for detecting and/or quantifying a target molecule using the molecularly imprinted polymer sensor.

In general terms, the invention relates to a hydrophobic polymer-based molecularly imprinted polymer sensor which may include some non-covalent interactions, static dipole-dipole interactions, van der Waals forces and hydrophobic interactions between the hydrophobic polymer comprised in the sensor and the target molecules, but not hydrogen bonding. The advantage of the molecularly imprinted hydrophobic polymer sensors of the present invention is that they have good selectivity, reliability and high sensitivity to the target molecules. Further, the molecularly imprinted hydrophobic polymer sensors also allow for fast detection of the target analytes, and provide a low-cost and simple preparation method for making the molecularly imprinted hydrophobic polymer sensors.

According to a first aspect, the present invention provides a molecularly imprinted polymer sensor for sensing a target molecule, comprising:
a molecularly imprinted polymer film comprising a hydrophobic polymer host with one or more binding sites for one or more target molecules, wherein the one or more target molecules is hydrophobic; and
a sensing substrate,
   wherein the molecularly imprinted polymer film is coated on a surface of the sensing substrate.

According to a particular aspect, the molecularly imprinted polymer film may be synthesised using one or more polymers and/or monomers with cross-linking agents.

The hydrophobic polymer host may be any suitable hydrophobic polymer for the purposes of the present invention. For example, the hydrophobic polymer host may be selected from the group consisting of: polyvinylidene difluoride (PVDF), polytetrafluoroethylene, polyvinylfluoride, polychlorotrifluoroethylene, polyhexafluoropropylene, polyethylene, polypropylene, polybutene, polyisobutylene, poly(4-methyl-1-pentene), poly(1-decene), polychloroprene, polyisoprene, poly(ethylene-co-tetrafluoroethylene), poly(vinylidene-co-hexafluoropropylene), poly(vinylchloride), polystyrene (PS), poly(styrene-co-butadiene), poly(styrene-co-α-methylstyrene), polyacenaphthylene, poly(4-tert-butylstyrene), poly(4-methylstyrene), poly(4-vinylbiphenyl), poly(4-vinylphenol), polyvinylcyclohexane, copolymers thereof and mixtures thereof. In particular, the hydrophobic polymer host may be PVDF or PS. Even more in particular, the hydrophobic polymer host may be PVDF.

The target molecule may be any suitable target molecule for the purposes of the present invention. For example, the target molecule may be selected from the group consisting of: benzene, toluene, xylene, styrene, alkane, polycyclic aromatic hydrocarbons (PAHs) and their derivatives, polychlorinated biphenyls (PCBs) and their derivatives, ibuprofen, olanzapine, testosterone, budesonide, progesterone, levonorgestrel, fluticasone proprionate, 17α-ethinylestradiol, salbutamol, 17-betaestradiol, beclomethasone diproprionate, parathion methyl, parathion ethyl, cyclosarin, paraoxon methyl, paraoxon ethyl, diisopropyl methylphosphonate, endosulfan, atrazine, diuron, dichlorodiphenyltrichloroethane (DDT), furadan, carbosulfan, carbaryl, linuron, heptachlor, permethrin, hydrocortisone, prednisolone, methylprednisolone, dexametharone, triamcinolone, tetracycline, oxytetracycline, 2,4-dichlrophenoxyacetic acid, 8-hydroxyquinoline, ascochlorin, aflatoxins, carbadox, cephalomannine, cefpodoxime, clarithromycin, erythromycin ethylsuccinate, ethionamide, tacrolimus, geldanamycin, griseofulvin, levofloxacin, lovastatin, mecillinam, roxithromycin, salinomycin, salinomycin sodium, tamoxifen, tigecycline, tyrothricin and combinations thereof. In particular, the target molecule may be parathion methyl (PTM).

The molecularly imprinted polymer film comprised in the molecularly imprinted polymer sensor may be of any suitable thickness. For example, the thickness of the molecularly imprinted polymer film may be ≤1 μm. In particular, the thickness may be 0.01-1.0 μm, 0.05-0.95 μm, 0.1-0.9 μm, 0.15-0.85 μm, 0.2-0.8 μm, 0.25-0.75 μm, 0.3-0.7 μm, 0.35-0.65 μm, 0.4-0.6 μm, 0.45-0.55 μm. Even more in particular, the thickness may be 0.44 μm.

The sensing substrate comprised in the sensor may indicate changes in at least one of: resistance, capacitance, mass, colour and resonance frequency. In particular, the sensing substrate may indicate changes in mass.

According to a second aspect, there is provided a method of making the molecularly imprinted polymer sensor. The method comprises the steps:
preparing a molecularly imprinted polymer solution comprising a hydrophobic polymer host, one or more target molecules and a first solvent;
coating the molecularly imprinted polymer solution onto a surface of a sensing substrate to form a molecularly imprinted polymer film;
drying the molecularly imprinted polymer film, wherein the drying temperature is ≤60° C.; and
removing the one or more target molecules from the molecularly imprinted polymer film, wherein the removing comprises extracting the one or more target molecules from the molecularly imprinted polymer film using a second solvent, wherein the polymer host is insoluble in the second solvent, and wherein the one or more target molecules are soluble in the second solvent.

According to a particular aspect, the coating comprises any suitable method of forming a film on a substrate surface. In particular, the coating may comprise: electrospinning, laser deposition, spin casting, dipping, direct dropping or a combination thereof. Even more in particular, the coating comprises electrospinning.

According to a particular aspect, the extracting may comprise soaking the sensing substrate with the molecularly imprinted polymer film on the surface of the sensing substrate in the second solvent for a pre-determined period of time.

The first solvent and the second solvent may be any suitable types of solvent. For example, the first solvent may be selected from the group consisting of: dimethylformamide (DMF), dimethylacetamide (DMAc), tetrahydrofuran (THF), methyl ethyl ketone (MEK), tetramethyl urea, dimethyl sulfoxide (DMSO), butanone, trimethyl phosphate and a combination thereof. The second solvent may be selected from the group consisting of: isopropyl alcohol, methanol, ethanol, 1-propanol, n-butanol, 2-butanol, 2-methyl-2-propanol, 2-methyl-1-propanol, 1-pentanol, isomeric alcohols thereof and a combination thereof.

According to a particular aspect, the molecularly imprinted polymer film may be synthesised using one or more polymers and/or monomers with cross-linking agents.

According to another aspect of the present invention, there is provided a method for detecting and/or quantifying a target molecule using the molecularly imprinted polymer sensor. The method comprises:
exposing the molecularly imprinted polymer sensor to a sample of fluid containing or thought to contain the target molecule, thereby allowing the target molecule, if present, to be received within cavities of the sensor; and
detecting the presence of and/or quantifying the amount of the target molecule bound to the cavities of the sensor using electrochemical, acoustical, spectroscopic, optical or indirect chromatographic techniques.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a scanning electron microscope (SEM) micrograph of a MIP film spin-coated onto a gold surface of a sensing substrate according to one embodiment;

FIG. 2 shows a PVDF-based MIP sensor with imprinted PTM cavities according to one embodiment;

FIG. 3 shows the response of non-imprinted PVDF polymer (NIP) to PTM solution. Line F1 and squares F3 represent the base frequency and the 3^{rd} overtone frequency of the NIP sensor, while the line D1 and squares D3 represent the base dissipation of the 3^{rd} overtone frequency of the NIP sensor. The stable and sensitive F3 was used for ΔF calculation;

FIG. 4 shows the response of PVDF MIP with 10% imprinted PTM molecular cavities when contacted with PTM solution. F3 indicates the 3^{rd} overtone frequency of the MIP sensor;

FIG. 5 shows the response of PVDF MIP (10% imprinted cavities) and NIP to PTM solution;

FIG. 6 shows the optimal soaking time for target molecule removal during the molecularly imprinting process;

FIG. 7 shows the optimal ratio of PVDF/PTM molecules during the molecularly imprinting process;

FIG. 8A shows the structures of different target molecules and FIG. 8B shows the selectivity of the MIP sensor according to one embodiment of the present invention to the different target molecules of FIG. 8A;

FIG. 9 shows the interaction between the PVDF MIP sensor and target molecule PTM;

FIG. 10 shows the sensor frequency changes ΔF with the different concentrations of the target molecule PTM;

FIG. 11 shows the calibration curve of PTM on the PVDF/MIP 1/1 sensor following removal of the target molecules as template molecules by soaking in IPA for 100 hours; and

FIG. 12 shows the response of polystyrene-based MIP to 28.0 ppm PTM using QCM.

### DETAILED DESCRIPTION

As explained above, there is a need for an improved sensor which is capable of sensing hydrophobic analytes as existing sensors have difficulties to detect more hydrophobic analytes in water.

The present invention provides a hydrophobic polymer-based sensor. In particular, the sensor is a molecularly imprinted hydrophobic polymer sensor which shows good response in detecting hydrophobic analytes. Further, the sensor of the present invention exhibits a fast response time in detecting target analytes, a low limit of detection, which is comparable to limits of detection using other sensors which may be more difficult to make or which require a longer time to detect the analytes. It is also more cost-effective to make the sensor of the present invention, as well as using a scalable and reproducible method since the method is based on molecular imprinting.

Molecular imprinting is a technique to produce molecule specific receptors analogous to those receptor binding sites in biochemical systems. A molecularly imprinted polymer (MIP) is a polymer that is formed in the presence of a template or target analyte molecule producing a complementary cavity that is left behind in the MIP when the template is removed. The MIP demonstrates affinity for the original template molecule over other related and analogous molecules.

According to a first aspect, the present invention provides a molecularly imprinted polymer sensor for sensing a target molecule, comprising:
a molecularly imprinted polymer film comprising a hydrophobic polymer host with one or more binding sites for one or more target molecules, wherein the one or more target molecules is hydrophobic; and
a sensing substrate,
   wherein the molecularly imprinted polymer film is coated on a surface of the sensing substrate.

Without being bound by any particular theory, the target molecule may bind to the binding sites in the polymer host via non-covalent interactions such as, but not limited to, hydrophobic interactions, static dipole-dipole interactions, van der Waals forces and a combination thereof.

The hydrophobic polymer host may be any suitable hydrophobic polymer for the purposes of the present invention. For example, the hydrophobic polymer host may be, but not limited to, polyvinylidene difluoride (PVDF), polytetrafluoroethylene, polyvinylfluoride, polychlorotrifluoroethylene, polyhexafluoropropylene, polyethylene, polypropylene, polybutene, polyisobutylene, poly(4-methyl-1-pentene), poly(1-decene), polychloroprene, polyisoprene, poly(ethylene-co-tetrafluoroethylene), poly(vinylidene-co-hexafluoropropylene), poly(vinylchloride), polystyrene (PS), poly(styrene-co-butadiene), poly(styrene-co-α-methylstyrene), polyacenaphthylene, poly(4-tert-butylstyrene), poly(4-methylstyrene), poly(4-vinylbiphenyl), poly(4-vinylphenol), polyvinylcyclohexane, copolymers thereof and mixtures thereof. In particular, the hydrophobic polymer host may be PVDF or PS. Even more in particular, the hydrophobic polymer host may be PVDF.

PVDF is very stable in aqueous solutions. Therefore, the sensor according to the present invention comprising PVDF as the polymer host may be long-lasting.

The target molecule may be any suitable target molecule for the purposes of the present invention. In particular, the target molecule may be hydrophobic. For example, the target molecule may be, but not limited to: hydrocarbons such as benzene, toluene, xylene, styrene, alkane; polycyclic aromatic hydrocarbons (PAHs) and their derivatives such as anthracene, pyrene, naphthalene, phenanthrene, chrysene, corannulene, coronene, hexaheicene; polychlorinated biphenyls (PCBs) and their derivatives such as PCB-77, PCB-114, polychlorinated dibenzo-p-dioxins (PCDDs), polychlorinated dibenzofurans; drug residues such as ibuprofen, olanzapine, testosterone, budesonide, progesterone, levonorgestrel, fluticasone proprionate, 17α-ethinylestradiol; animal growth promoters such as salbutamol, 17-betaestradiol, beclomethasone diproprionate; pesticides such as parathion methyl (PTM), parathion ethyl, cyclosarin, paraoxon methyl, paraoxon ethyl, diisopropyl methylphosphonate, endosulfan, atrazine, diuron, dichlorodiphenyltrichloroethane (DDT), furadan, carbosulfan, carbaryl, linuron, heptachlor, permethrin, hydrocortisone, prednisolone, methylprednisolone, dexametharone, triamcinolone, tetracycline, oxytetracycline, 2,4-dichlrophenoxyacetic acid, 8-hydroxyquinoline, ascochlorin, aflatoxins, carbadox, cephalomannine, cefpodoxime, clarithromycin, erythromycin ethylsuccinate, ethionamide, tacrolimus, geldanamycin, griseofulvin, levofloxacin, lovastatin, mecillinam, roxithromycin, salinomycin, salinomycin sodium, tamoxifen, tigecycline, tyrothricin; or combinations thereof. In particular, the target molecule may be parathion methyl (PTM).

According to a particular embodiment, the target molecule may also comprise homologous molecules, homologs, of the target molecule. Homologs of the target molecules may include molecules that are similar to the target molecule in various attributes such as, but not limited to, size, electrostatic potentials, electronegativity, charge density, chemical bonding potential, and molecules that have similar shapes to the target molecule. Homologs may include isomers and stereoisomers of the target molecule.

As used herein, the molecularly imprinted polymer (MIP) film may be a coating on a surface or part of a surface of a sensing substrate. The MIP film comprised in the molecularly imprinted polymer sensor may be of any suitable thickness. For example, the thickness of the MIP film may be ≤1 μm. In particular, the thickness may be 0.01-1.0 μm, 0.05-0.95 μm, 0.1-0.9 μm, 0.15-0.85 μm, 0.2-0.8 μm, 0.25-0.75 μm, 0.3-0.7 μm, 0.35-0.65 μm, 0.4-0.6 μm, 0.45-0.55 μm. Even more in particular, the thickness may be 0.44 μm. Even more in particular, the thickness may be 0.44 μm.

According to a particular aspect, the MIP sensor functionality may depend on detecting differences in a property of the MIP film as a function of the adsorption of a target molecule. In particular, a change in a property associated of the polymer host comprised in the MIP film may indicate the presence of a target molecule in a MIP film. The absence of a change may indicate the absence of a target molecule in a MIP film. The change may be an alteration in any measurable property of the polymer host. For example, the change may be a change in capacitance, resistance, colour, mass, resonance frequency, or the like. In particular, the change may be indicated by the sensing substrate comprised in the sensor. For example, the MIP film may be coated onto an electrode and a change in the resistance of the polymer host comprised in the MIP film between the adsorbed and desorbed state may be used to detect a target molecule. Even more in particular, the sensing substrate may indicate changes in mass.

Accordingly, the sensing substrate may be any suitable sensing substrate for the purposes of the present invention. In particular, the sensing substrate is selected such that the sensing substrate is suitable for being able to indicate the change in a measureable property of the polymer host during the detection or target molecules. For example, the sensing substrate may be a quartz crystal substrate, a metal-based substrate, an oxide-based conductive glass substrate, and the like.

According to a particular aspect, the sensing substrate may be a quartz crystal substrate. The quartz crystal substrate may be coated, for example with silver, gold, or the like. The quartz crystal may be suitable for quartz crystal microbalance (QCM).

According to another particular aspect, the sensing substrate may be a metal-based substrate. The metal-based substrate may be suitable for surface plasmonic resonance (SPR).

According to another particular aspect, the sensing substrate may be indium tin oxide (ITO) or fluoride-doped tin oxide (FTO) conductive glass substrate suitable for electrochemical sensing systems.

According to a particular aspect, the molecularly imprinted polymer film may be synthesised using one or more polymers and/or monomers with cross-linking agents. Any suitable polymer, monomer or cross-linking agent may be used for the purposes of the present invention. In particular, the polymer may be a hydrophobic polymer as described above in relation to the hydrophobic polymer host. The cross-linking agent may comprise, but is not limited to, peroxide with or without a coagent, dithiols in combination with amines, aromatic polyhydroxyl compounds, diamines and their derivatives, thiolene systems and high energy radiation.

The MIP sensor may be a device that simultaneously monitors one or more target molecules. According to a particular aspect, the MIP sensor may be read visually. According to another particular aspect, the MIP sensor may be coupled to electronics that read the MIP film on the sensing substrate and report wirelessly to a central facility. Alternatively, the MIP sensor may be incorporated into a portable and/or handheld device for measurement and processing onsite. The polymer host and the synthesis of the MIP film for each target molecule may be determined by the physical and/or chemical characteristics of the target molecules. For example, the MIP sensor may comprise one or more MIP films, wherein each MIP film within the MIP sensor, such as a test strip, may be specific to a single target molecule.

According to a second aspect, there is provided a method of making the molecularly imprinted polymer sensor, the method comprising:
preparing a molecularly imprinted polymer solution comprising a hydrophobic polymer host, one or more target molecules and a first solvent;
coating the molecularly imprinted polymer solution onto a surface of a sensing substrate to form a molecularly imprinted polymer film;
drying the molecularly imprinted polymer film, wherein the drying temperature is ≤60° C.; and
removing the one or more target molecules from the molecularly imprinted polymer film, wherein the removing comprises extracting the one or more target molecules from the molecularly imprinted polymer film using a second solvent, wherein the polymer host is insoluble in the second solvent, and wherein the one or more target molecules are soluble in the second solvent.

The preparing may comprise mixing the hydrophobic polymer host, the one or more target molecules and the first solvent. According to a particular aspect, various orders of addition and mixing of the hydrophobic polymer host, target molecule and first solvent may be used. The amount of hydrophobic polymer host, target molecule and first solvent added to the MIP solution may depend on the hydrophobic polymer host, the target molecule and the first solvent being used. In particular, the amounts of hydrophobic polymer host, target molecule and first solvent added to the MIP solution is also selected such that the thickness of the MIP film formed from the MIP solution is ≤1 μm.

The hydrophobic polymer host and the target molecule may be as described above in relation to the first aspect. The first solvent may be any suitable solvent. The choice of the first solvent may depend on the hydrophobic polymer host and the target molecule. Examples of suitable solvents include, but are not limited to, dimethylformamide (DMF), dimethylacetamide (DMAc), tetrahydrofuran (THF), methyl ethyl ketone (MEK), tetramethyl urea, dimethyl sulfoxide (DMSO), butanone, trimethyl phosphate and a combination thereof, and the like.

Following the preparation of the molecularly imprinted polymer (MIP) solution, the MIP solution may then be coated onto a surface of a sensing substrate to form a MIP film and allowed to dry. The coating may be by any suitable coating method. For example, the coating may be by electrospinning, dip coating, laser deposition, spin casting, dipping, direct dropping or a combination thereof. Even more in particular, the coating comprises electrospinning the MIP solution onto a surface of a sensing substrate. The sensing substrate may be as described above.

After the coating, the MIP film coated onto the surface of the sensing substrate is allowed to dry. The drying may be under any suitable conditions. For example, the drying may be under suitable conditions to enable the polymer host to form the binding sites for the dissolved target molecules. The drying may be at a suitable temperature. For example, the drying may be at a temperature of ≤60° C. In particular, the drying may be at 15-60° C., 20-55° C., 25-50° C., 30-45° C., 35-40° C. Even more in particular, the drying may be at 20-25° C. According to a particular embodiment, the drying may be by air drying or nitrogen drying.

Once the MIP film is dried, the target molecules may be selectively removed from the MIP film. When the target molecule is removed, it may leave behind a MIP film with cavities complementary in shape and functionality to the target molecule, which can rebind, in the cavities, a target identical to the original target molecule. For example, the removing may be by extraction with a second solvent. In particular, the second solvent is selected such that the polymer host is insoluble in the second solvent and the target molecules are soluble in the second solvent.

According to a particular aspect, the extracting may comprise soaking the sensing substrate with the molecularly imprinted polymer film on the surface of the sensing substrate in the second solvent for a pre-determined period of time.

For example, the second solvent may be selected from the group consisting of: isopropyl alcohol, methanol, ethanol, 1-propanol, n-butanol, 2-butanol, 2-methyl-2-propanol, 2-metyhl-1-propanol, 1-pentanol, isomeric alcohols thereof and a combination thereof.

In particular, the first solvent is such that it boils at a lower temperature than the target molecule. This may allow the target molecules to form recognition sites during spinning or dip coating. The second solvent used for removing the target molecules should be incompatible with the polymer host to promote precipitation of the MIP film. Alternatively, the target molecule may be evaporated from the MIP film if the second solvent has a lower boiling point than the target molecule.

According to a particular aspect, the MIP film may be synthesised using one or more polymers and/or monomers with cross-linking agents. If polymers are used, the method of the present invention avoids additional steps of polymerization. If, instead, monomers are used for the synthesis of the MIP film, monomer polymerization is required and this in turn requires addition of cross-linking agents. However, it would be more advantageous to use polymers for the synthesis of the MIP film. This is because if monomers are used for the synthesis of the MIP film, the cross-linking agent added together with the monomers in the MIP solution may react with the target molecules used as template molecules and such reaction should be avoided. Accordingly, if the method of the present invention comprises the addition of monomers in the MIP solution, careful selection of the monomers, cross-linking agents may be required so as to avoid any reaction with the target molecules used as template molecules.

According to a third aspect of the present invention, there is provided a method for detecting and/or quantifying a target molecule using the molecularly imprinted polymer sensor of the first aspect. The method comprises:
exposing the molecularly imprinted polymer sensor to a sample of fluid containing or thought to contain the target molecule, thereby allowing the target molecule, if present, to be received within cavities of the sensor; and
detecting the presence of and/or quantifying the amount of the target molecule bound to the cavities of the sensor using electrochemical, acoustical, spectroscopic, optical or indirect chromatographic techniques.

The interaction between a polymer host and a target molecule in a MIP may involve associations between the polymer host and the target molecule. The binding interaction may exploit other various forces in conjunction with shape recognition, but the interaction between polymer host and the target molecule can include any interactions between the target molecule and the polymer host.

According to a particular aspect, the target molecule may be as described above. In particular, the target molecule may be PTM.

According to a particular aspect, the detecting using electrochemical, acoustical, spectroscopic or optical techniques may comprise measuring a change of a measurable property of the MIP film, wherein a change comes about when the target molecule is detected in the MIP film. The change of the measureable property may be a change in capacitance, resistance, colour, mass, resonance frequency, or the like.

The present invention will be exemplified by the following non-limiting examples.

### Example 1

In this example, the hydrophobic polymer host is PVDF and the target molecule is PTM.

An MIP sensor was prepared using PVDF as the hydrophobic polymer host and parathion methyl (PTM) was used as template and target molecules. First, 40 μL of a molecularly imprinted polymer (MIP) solution was spin-coated at 2500 rpm for 20 seconds onto a gold (Au)-coated quartz crystal chip and subsequently air dried. In particular, the MIP solution comprised 1 ml of dimethylformamide (DMF), 0.025 g of PVDF, and 0.0025 g of PTM.

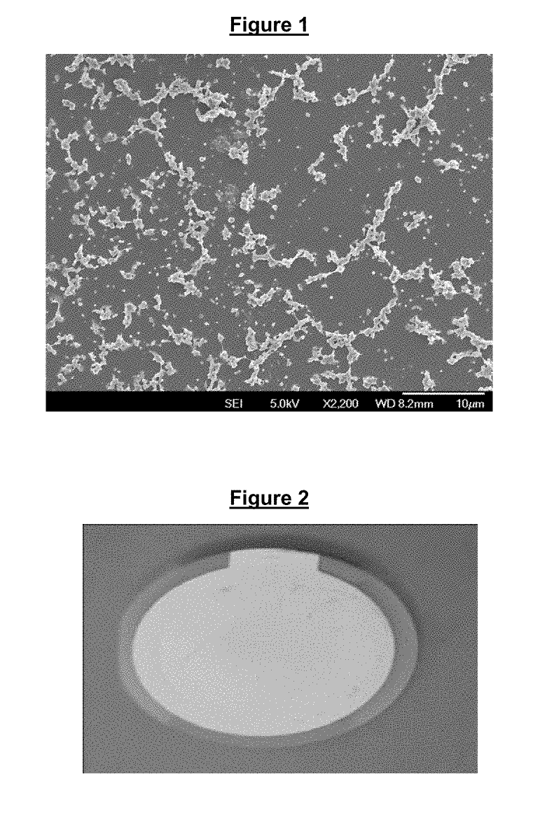

As seen from FIG. 1, the PVDF MIP film was not completely formed on the gold-coated quartz crystal chip. In particular, direct drying of 40 μL of the MIP solution on the Au-coated quartz chip, having Au surface diameter 9.5 mm and a bare chip base frequency of 4.98 MHz, resulted in a film thickness of 8.7 μm, which was too thick to be recognized by the QSense Quarts Crystal Microbalance (QCM). When the MIP solution was diluted to 10 or 20 times with DMF, the formed PVDF film thickness was 0.44 or 0.87 μm, respectively, which could be well recognized by the QCM. The 0.43 μm PVDF film had a better S/N ratio than the 0.87 μM film. Therefore, a MIP film thickness below 1 μm is preferred as a MIP film with a lower thickness has a higher S/N ratio.

For QCM, the mass change of the MIP sensor with and without the adsorption of target molecules follows the QCM mass-frequency effect, Sauerbrey equation (Eq. 1):

$$Δ F = - 2.26 \times {10}^{6} \times {F}^{2} \times \frac{Δ m}{A} = - \frac{2 {f}_{0}^{2} Δ m}{A \sqrt{μρ}} , \qquad ( Eq . 1 )$$

where ΔF is the measured frequency change (Hz), F & f₀—fundamental resonance frequency (MHz), Δm—mass adsorbed, A—area coated by MIP film, μ—shear modulus of quartz, ρ—density of quartz.

Since the MIP method was utilized to prepare the PVDF MIP film and PTM was used as the template molecules, PTM was needed to be removed after the PTM-PVDF film was formed. In this specific design, solvent was used to remove the template molecules. A solvent was first needed for both PTM and PVDF to dissolve them to form a uniform single phase. The solvent used was DMF as it is a solvent for both PVDF and PTM. Second, a PTM solvent was needed to remove the template molecules but this solvent must be a non-solvent for the PVDF. Accordingly, isopropyl alcohol (IPA) was used as a PTM solvent. In particular, the method used to prepare the MIP sensor was as follows:
(a) Cleaning a Au-coated quartz chip with DMF flush;
(b) Spin coating 20 μL of MIP solution comprising 0.138% PVDF and PTM in DMF onto the surface of the Au-coated quartz chip to form a PVDF film;
(c) Air drying the Au-coated quartz chip at room temperature;
(d) Soaking the chip in 10 mL of IPA for a period of time (i.e. 0, 15, 100, 265 hours); and
(e) Removing the chip from the IPA, rinsing the chip with IPA and blowing it dry with purified nitrogen gas.

The PVDF MIP sensor formed from the above method is shown in FIG. 2. In particular, the PVDF-based MIP sensor had PTM cavities imprinted on the PVDF film.

When the above method was repeated without the addition of PTM, the PVDF film formed was a non-imprinted polymer (NIP) film. The method formed a NIP sensor.

Both the PVDF-based MIP sensor and the NIP sensor were then exposed to PTM to test how well the sensors detected the PTM molecules. As explained above, the frequency change ΔF was measured as a correlation of the amount of PTM molecules detected by the sensor.

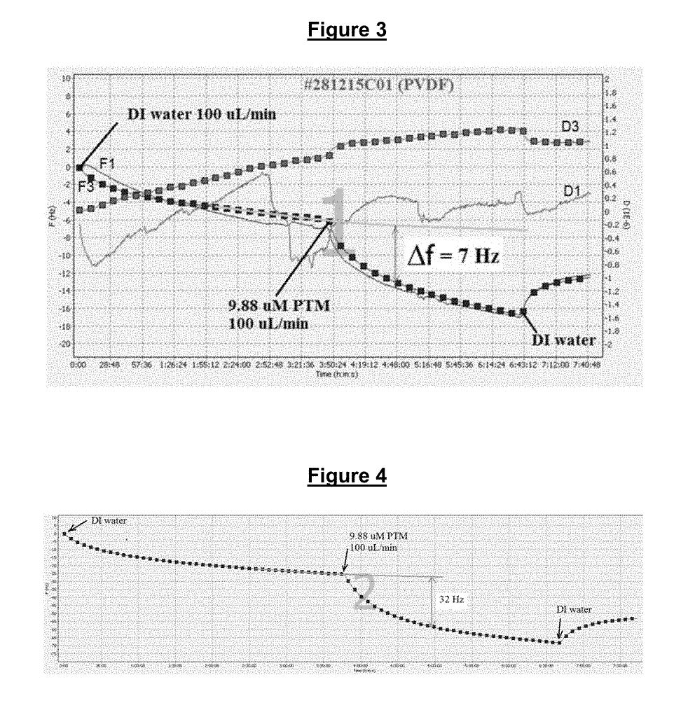

The NIP film of the NIP sensor absorbed only very limited amounts of PTM as can be seen in FIG. 3. In particular, the frequency change ΔF of the NIP sensor was 7.0 Hz in 70 minutes when contacted with 9.88 μM PTM.

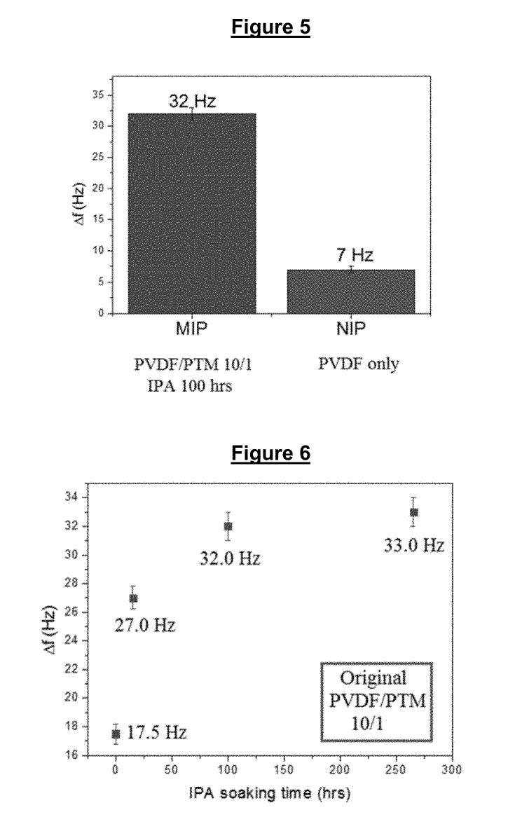

When the original PVDM/PTM ratio was 10/1 and the soaking time in IPA for PTM removal was 100 hours, the prepared MIP sensor had a ΔF of 32.0 Hz when contacted with 9.88 μM PTM for 70 minutes (see FIG. 4). The MIP sensor had a much higher (4.6 times) value of ΔF compared to the NIP sensor, which made the sensor sensitive and detection of target analyte possible as shown in FIG. 5.

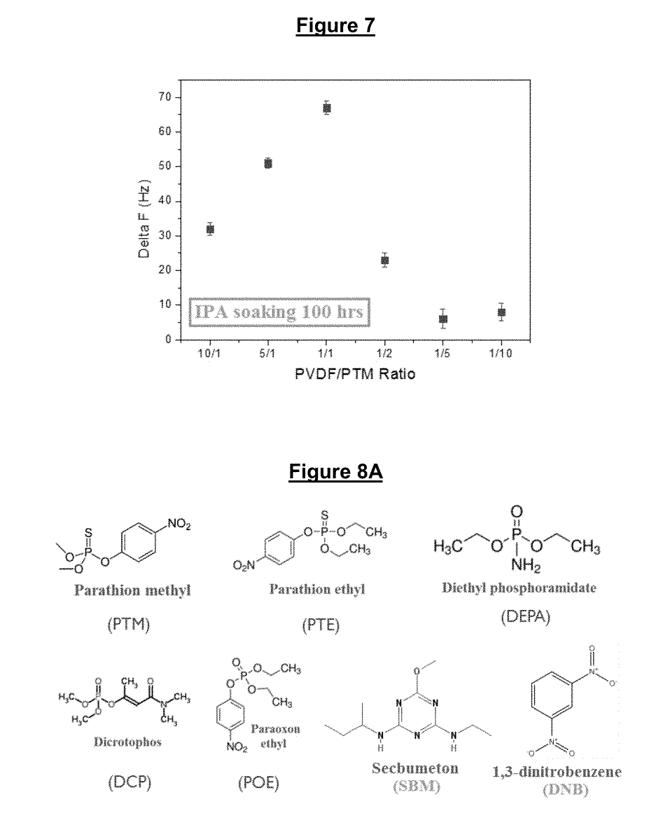

The soaking time of the chip in IPA was also optimised from 0 to 265 hours. As seen in FIG. 6, 100 hours of soaking was determined to be an optimum time.

Subsequently, different PVDF and PTM template ratios were also tested to find the optimum ratio of PVDF/PTM weight ratio. The different ratios tested were 10/1, 5/1, 1/1, 1/2, 1/5 and 1/10. FIG. 7 shows that the weight ratio 1/1 of PVDF/PTM is optimum. This weight ratio is denoted as “PVDF 1/1”. When the PVDF/PTM ratio was 1/1, after template removal, the imprinted PTM molecular cavities accounted for about 50% of the whole film.

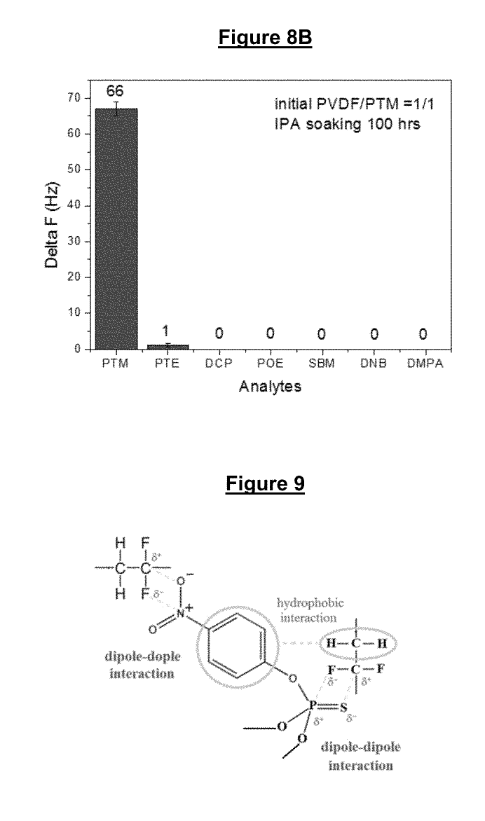

To exhibit the selectivity of the MIP sensor, tests were carried out on the PVDF/PTM 1/1 MIP sensor using a few PTM analogues such as parathion ethyl (PTE), dicrotophos (DCP), paraoxon ethyl (POE), secbumeton (SBM), 1,3-dinitrobenzene (DNB) and diethyl phosphoramidate (DEPA). The chemical structures of the various analogues are shown in FIG. 8A. As can be seen from FIG. 8B, the PVDF1/1 MIP sensor had very high selectivity of PTM over the other analogues. In particular, response of PVDF/PTM 1/1 MIP sensor to 9.88 μM PTM in 70 minutes was 66 Hz ΔF, while the ΔF value for PTE, DCP, POE, SBM, DNB and DEPA was 1, 0, 0, 0, 0 and 0 Hz under the same conditions. The high selectivity of PVDF/PTM 1/1 MIP sensor for PTE over the other analogues as target molecules could be explained in view of the interactions between the PVDF/PTM 1/1 MIP sensor and the various analytes.

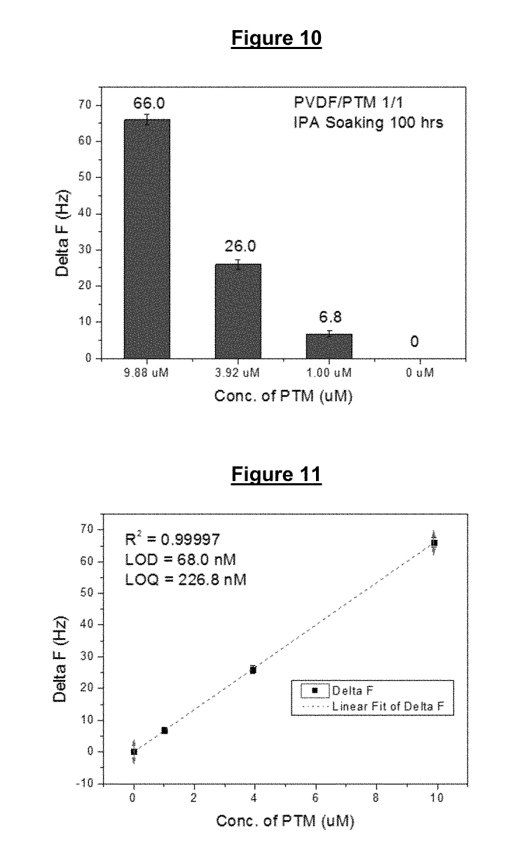

As shown in FIG. 9, there were a number of interactions between the PVDF/PTM 1/1 MIP sensor and PTM as follows:
dipole-dipole interactions between polarized —C—F— units (some δ⁺ on C, some δ⁻ on F) in PVDF and —NO₂ groups (some δ⁺ on N, some δ⁺ on O) in PTM;
hydrophobic interactions between non-polarized —H—C—H— units in PVDF and hydrophobic benzene ring in PTM;
dipole-dipole interactions between polarized —C—F— units (some δ⁺ on C, some δ⁻ on F) in PVDF and —P═S fractions (some δ⁺ on P, some δ⁻ on S).

However, PTE and POE are bigger molecules than PTM due to their larger ethyl group and its steric hindrance, which makes them difficult to be captured by the PTM imprinted molecular cavities on the PVDF-MIP sensor. Although DCP is a smaller molecule than PTM, it has weaker dipole-dipole interactions and hydrophobic interactions with PTM due to the lack of polarized nitro groups and hydrophobic benzene ring. SBM is also less hydrophobic, has a different molecular shape from PTM and has weaker d-d interactions with PVDF. DNB is a smaller molecule than PTM and it has a different molecular shape from PTM. DEPA has less d-d interactions with PVDF and it is smaller and less hydrophobic than PTM.

Once it had been established that the PVDF/PTM 1/1 MIP sensor had good selectivity for PTM, sensitivity tests were carried out. These tests were carried out on 9.88, 3.92, 1.00 and 0 μM of PTM solution. The results of the tests are shown in FIG. 10. In particular, the frequency changes ΔF were proportional to the PTM concentration. FIG. 11 shows the calibration curve of PTM on the fabricated PVDF/PTM 1/1 MIP sensor with the template PTM molecules removed by IPA after soaking for 100 hours. The linearity of the calibration curve is as good as 0.99997. From the calibration curve, the limit of detection (LOD) and limit of quantification (LOQ) was determined to be 68.0 and 226.8 nM, respectively.

The LOD of PTM using the fabricated PVDF/PTM 1/1 MIP sensor is comparable to the reported LOD of PTM using other sensors.

### Example 2

A polystyrene (PS)-based MIP sensor was also fabricated in a similar manner as the PVDF-based MIP sensor of Example 1. The fabrication method was the same as that described in Example 1 except that PVDF was replaced with polystyrene powder having an average of 1 μm diameter.

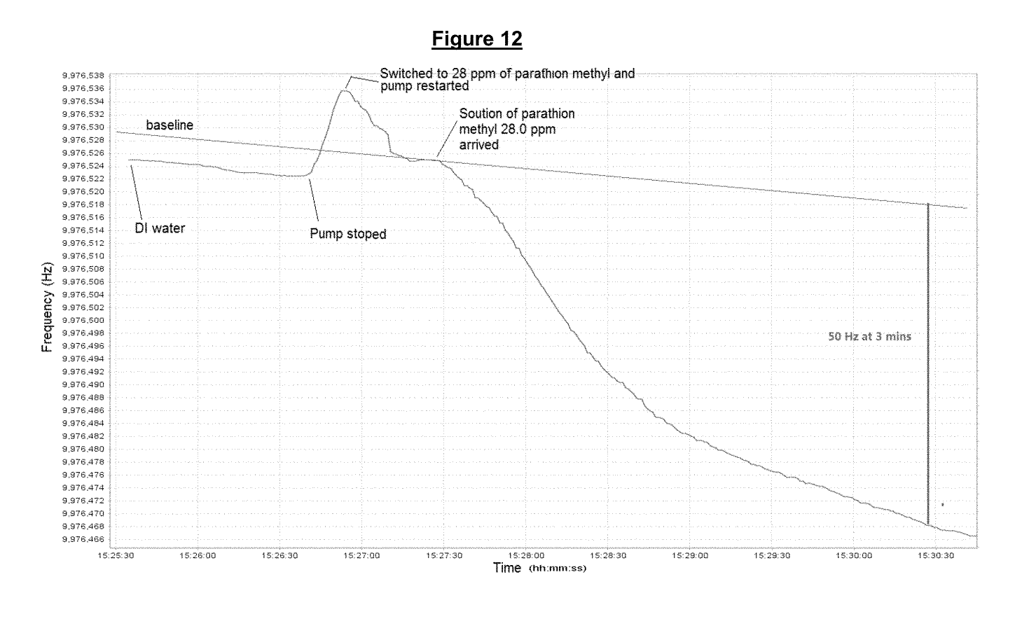

A PS-based MIP sensor comprising a PS-based MIP film of 33 nm thickness was fabricated for the detection of PTM using a weight ratio of 2:1 PS to PTM. The fabricated PS-based MIP was evaluated using QCM. A response of 50.0 Hz was obtained with flow (100 μl/min) of 28.0 ppm of PTM for 3 minutes, as shown in FIG. 12. This shows that PS-based MIP sensor was also feasible.

Whilst the foregoing description has described exemplary embodiments, it will be understood by those skilled in the technology concerned that many variations may be made without departing from the present invention.

1. A molecularly imprinted polymer sensor for sensing a target molecule, comprising:
a molecularly imprinted polymer film comprising a hydrophobic polymer host with one or more binding sites for one or more target molecules, wherein the one or more target molecules is hydrophobic; and
a sensing substrate,
wherein the molecularly imprinted polymer film is coated on a surface of the sensing substrate.

2. The sensor according to claim 1, wherein the molecularly imprinted polymer film is synthesised using one or more polymers and cross-linking agents.

3. The sensor according to claim 1, wherein the hydrophobic polymer host is selected from the group consisting of: polyvinylidene difluoride (PVDF), polytetrafluoroethylene, polyvinylfluoride, polychlorotrifluoroethylene, polyhexafluoropropylene, polyethylene, polypropylene, polybutene, polyisobutylene, poly(4-methyl-1-pentene), poly(1-decene), polychloroprene, polyisoprene, poly(ethylene-co-tetrafluoroethylene), poly(vinylidene-co-hexafluoropropylene), poly(vinylchloride), polystyrene, poly(styrene-co-butadiene), poly(styrene-co-α-methylstyrene), polyacenaphthylene, poly(4-tert-butylstyrene), poly(4-methylstyrene), poly(4-vinylbiphenyl), poly(4-vinylphenol), polyvinylcyclohexane, copolymers thereof and mixtures thereof.

4. The sensor according to claim 1, wherein the one or more target molecules is selected from the group consisting of: benzene, toluene, xylene, styrene, alkane, polycyclic aromatic hydrocarbons (PAHs) and their derivatives, polychlorinated biphenyls (PCBs) and their derivatives, ibuprofen, olanzapine, testosterone, budesonide, progesterone, levonorgestrel, fluticasone proprionate, 17α-ethinylestradiol, salbutamol, 17-betaestradiol, beclomethasone diproprionate, parathion methyl, parathion ethyl, cyclosarin, paraoxon methyl, paraoxon ethyl, diisopropyl methylphosphonate, endosulfan, atrazine, diuron, dichlorodiphenyltrichioroethane (DDT), furadan, carbosulfan, carbaryl, linuron, heptachlor, permethrin, hydrocortisone, prednisolone, methylprednisolone, dexametharone, triamcinolone, tetracycline, oxytetracycline, 2,4-dichlrophenoxyacetic acid, 8-hydroxyquinoline, ascochlorin, aflatoxins, carbadox, cephalomannine, cefpodoxime, clarithromycin, erythromycin ethylsuccinate, ethionamide, tacrolimus, geldanamycin, griseofulvin, levofloxacin, lovastatin, mecillinam, roxithromycin, salinomycin, salinomycin sodium, tamoxifen, tigecycline, tyrothricin, and combinations thereof.

5. The sensor according to claim 1, wherein the hydrophobic polymer host is PVDF or polystyrene.

6. The sensor according to claim 1, wherein the one or more target molecules is parathion methyl (PTM).

7. The sensor according to claim 1, wherein the molecularly imprinted polymer film has a thickness of ≤1 μm.

8. The sensor according to claim 1, wherein the sensing substrate indicates changes in at least one of: resistance, capacitance, mass, colour and resonance frequency.

9. A method of making the molecularly imprinted polymer sensor according to claim 1, comprising:
preparing a molecularly imprinted polymer solution comprising a hydrophobic polymer host, one or more target molecules and a first solvent;
coating the molecularly imprinted polymer solution onto a surface of a sensing substrate to form a molecularly imprinted polymer film;
drying the molecularly imprinted polymer film, wherein the drying temperature is ≤60° C., and
removing the one or more target molecules from the molecularly imprinted polymer film, wherein the removing comprises extracting the one or more target molecules from the molecularly imprinted polymer film using a second solvent, wherein the polymer host is insoluble in the second solvent, and wherein the one or more target molecules are soluble in the second solvent.

10. The method according to claim 9, wherein the coating comprises: electrospinning, laser deposition, spin casting, dipping, direct dropping or a combination thereof.

11. The method according to claim 9, wherein the extracting comprises soaking the sensing substrate with the molecularly imprinted polymer film on the surface of the sensing substrate in the second solvent for a pre-determined period of time.

12. The method according to claim 9, wherein the first solvent is selected from the group consisting of: dimethylformamide (DMF), dimethylacetamide (DMAc), tetrahydrofuran (THF), methyl ethyl ketone (MEK), tetramethyl urea, dimethyl sulfoxide (DMSO), butanone, trimethyl phosphate and a combination thereof.

13. The method according to claim 9, wherein the second solvent is selected from the group consisting of: isopropyl alcohol, methanol, ethanol, 1-propanol, n-butanol, 2-butanol, 2-methyl-2-propanol, 2-methyl-1-propanol, 1-pentanol, isomeric alcohols thereof and a combination thereof.

14. The method according to claim 9, wherein the molecularly imprinted polymer film is synthesised using one or more polymers and/or monomers with cross-linking agents.

15. A method for detecting and/or quantifying a target molecule using the molecularly imprinted polymer sensor according to claim 1, the method comprising:
exposing the molecularly imprinted polymer sensor to a sample of fluid containing or thought to contain the target molecule, thereby allowing the target molecule, if present, to be received within cavities of the sensor; and
detecting the presence of and/or quantifying the amount of the target molecule bound to the cavities of the sensor using electrochemical, acoustical, spectroscopic, optical or indirect chromatographic techniques.
